(19) United States
(12) Patent Application Publication
(10) Pub. No.: US 2013/0164729 A1
(43) Pub. Date: Jun. 27, 2013

(54) EDUCATIONAL DEVICE AND KIT THEREFORE

(71) Applicant: Jill S. Rappa, Kenilworth, NJ (US)

(72) Inventor: Jill S. Rappa, Kenilworth, NJ (US)

(21) Appl. No.: 13/761,899

(22) Filed: Feb. 7, 2013

Related U.S. Application Data
(63) Continuation-in-part of application No. 12/011,446, filed on Jan. 28, 2008, now abandoned.

(51) Int. Cl. G09B 19/00

(52) U.S. Cl. CPC G09B 19/00
USPC 434/365

(57) ABSTRACT

An educational device that includes a freestanding dispenser container having an interior and an opening to the interior thereof. A plurality of reusable sheets are in the container each having on at least one surface an educational graphic. The sheets are arranged in the container so as to be capable of being dispensed one at a time from the opening by a person grasping and removing each sheet sequentially from the container through the opening. A means is provided for refilling the container with the reusable sheets that have been removed from the container. A kit comprising a foam structure and plurality of sheets for converting commercially available wipe containers to an educational device.

### RELATED APPLICATIONS

This application is a continuation-in-part application of U.S. Ser. No. 12/011,446 filed on Jan. 28, 2008, now ______ , the entire disclosure of this application is incorporated herein.

### FIELD OF THE INVENTION

This invention relates to an educational device and kit used for teaching people, in particular children, certain skills, for example, letters, numbers, colors, and other similar type skills.

### BACKGROUND OF THE INVENTION

Disposable, pre-moistened cleansing wipes having embossed or printed patterns thereon are known, and are often referred to as wet wipes, towelettes, and the like. Such pre-moistened wipes include a substrate, such as a nonwoven web, pre-moistened with a lotion and are usually contained in a container that permits removal of one wipe at a time. For example, such wipes are usually dispensed from a container of stacked, folded wipes or dispensed as “pop-up” wipes, in which upon pulling a wipe out of the container, an edge of the next wipe is presented for easy dispensing. The wipes can he folded in any of various known folding patterns, such as C-folding or Z-folded. For example, a Z-folded configuration enables a folded stack of wipes to be interleaved with overlapping portions.

Such cleansing wipes, when in the hands of a child, often are rapidly wasted because the child is fascinated by the removal of the wipes from the container. The wipes that are removed must either be immediately used to wipe the child or an object and/or must be thrown away.

Through experimentation with children, it was soon discovered that such “pop-up” functionality could be the catalyst for not only a toy, but also an educational device and kit for educating children as well as adults.

Applicant is aware of the following references:

U.S. Pat. No. 6,361,784 to Brennan discloses a disposable, nonwoven wipe suitable for use as a pre-moistened baby wipe. The wipe is calendar-embossed with a pattern of a plurality of discrete icons of a specific size to provide superior softness and aesthetic appeal.

U.S. Patent Application 2007/0130709 to Cohen discloses a reusable cleansing sheet having advertisement or other information printed on it. The cleansing sheet includes various compositions to promote the cleansing process, e.g., soap, shampoo, lathering surfactant, and/or a lotion.

U.S. Patent Application 2005/0150784 to Sanchez discloses a cleansing mitt adapted to fit on a child's hand and releasably carrying a personal care composition. A set of visual prompts are provided on the mitt to enable a child that cannot read to clean himself.

U.S. Patent Application 2007/0045334 to Sherman discloses a pop-up bath tissue product designed to educate a child during toilet training. The dispenser is designed to dispense wiping tissues one at a time. The dispenser is attached to the wall in the toilet. The disposable tissue sheets and/or the dispenser may include designs or other indicia to encourage and/or to help educate a child during toilet training.

U.S. Patent Application 2007/0144929 to Minerath discloses a packaging system for consumer products.

U.S. Patent Application 2006/0193898 to Norman discloses disposable baby wet wipe products that have sensory elements targeted to groups of consumers, e.g., scent elements, visual elements, tactile elements and auditory elements.

U.S. Patent Application 2005/0125877 to Benjamin describes a disposable nonwoven mitt with a child graphic disposed thereon that releasably carries a composition such as a shampoo.

U.S. Pat. No. 7,182,217 to Windorski discloses sheet dispensers.

U.S. Pat. No. 6,520,330 to Batra discloses a package and a disposable consumer product that is dispensed therefrom that have the same decorative indicia.

U.S. Pat. No. 6,427,839 to Helfer-Grand discloses an apparatus for hands-free portability, single-handed dispensing of folded and stacked pre-moistened antiseptic disposable towelettes

U.S. Pat. No. 6,224,107 to Smith discloses a pocketbook adapted to be customized by a consumer.

U.S. Pat. No. 5,641,062 to Burton discloses a combined greeting card and gift box apparatus having a box portion which when in the open position, the recipient, may begin withdrawing bills of currency, gift certificates, checks or other like objects.

U.S. Pat. No. 4,648,548 to Shin discloses a container which is provided with a plurality of decorative figures defined by cut lines or perforations disposed in the surfaces of the container. After the container is no longer functioning as a container, the decorative figures disposed in the walls thereof can be either cut or punched from the container walls and used for a variety of purposes.

Additional references include:

U.S. Patent 2003/0006253 to Yelton et al

U.S. Pat. No. 6,550,634 to Alegre De Miguci

U.S. Pat. No. 6,331,696 to Nakamura et al

U.S. Pat. No. 6,213,344 to Hiji

U.S. Pat. No. 5,720,617 to Var

U.S. Pat. No. 3,836,044 to Tilp et al

U.S. Pat. No. 3,826,406 to Moniot

U.S. Pat. No. 1,362,449 to Teall

The references disclose “pop-up” dispensers for disposable sheets that may have decorative or educational graphics thereon. However, none of the references teach or suggest an educational device having a dispenser with an opening thererein, a plurality of reusable educational or entertaining sheets therein that are maintained against such opening that are sequentially withdrawn, and a kit to convert the known commercially available containers for wipes to such educational device.

### OBJECTS AND SUMMARY OF THE INVENTION

It is an object of this invention to provide an educational device and kit for such device that is easy and fun to use, particularly for children.

It is another object of this invention to provide an educational device that is inexpensive and easy to use.

It is still another object of this invention to provide an educational device that is simple to use and can be repeatedly used without becoming boring to a child.

It is yet another object of this invention to provide an educational device that provides a means for varying the topic of education for the person using it.

It is yet another object of this invention to provide a kit to easily and safely convert containers that hold sanitary wipes into an educational device suitable for use children.

The educational device described and claimed herein achieves all of these objects. Broadly, the device comprises a freestanding dispenser container having an interior and an opening to the interior thereof. A plurality of reusable sheets are in the container each having on at least one surface an educational graphic. The sheets are arranged in the container so as to be capable of being dispensed one at a time from the opening by a person grasping and removing each sheet sequentially from the container through the opening. A means is provided for refilling the container with the reusable sheets that have been removed from the container.

More specifically, the educational training device includes:

a free-standing dispenser container having a top, a bottom, an interior formed by walls, and a container opening at the top of the container;

an interior plate removably engaged with the walls having an opening through the interior plate;

a compressible polymeric foam structure having a bottom surface in contact with the bottom of the container, an upper surface below the interior plate and sidewalls; and

a plurality of reusable sheets that are not pre-moistened or wet having on at least one surface of each sheet an educational graphic, the sheets being arranged in the container between the interior plate and the upper surface of the compressible polymeric foam structure so as to be capable of being dispensed one at a time from the opening in the interior plate by a person grasping and removing each sheet sequentially through the container opening.

The compressible polymeric foam structure positioned between the interior plate and the bottom of the container maintains a continuous upward force for maintaining the sheets in constant contact with the interior plate as each of the reusable sheets are removed from the container to thereby provide access to the sheets through the opening in the interior plate.

A person can thus remove each reusable sheet from the container by pulling on the sheet through the opening in the interior plate, view the educational graphic on the sheet, and sequentially repeat the process until the container is empty of reusable sheets. The compressible polymeric foam structure maintains the reusable sheets in constant contact with the interior plate. The container is then refilled with the plurality of sheets that have been removed from the container by disengaging the interior plate from the walls and placing the sheets on top of the compressible polymeric foam structure, returning the interior plate to its original position engaged with the walls and the process is repeated.

A kit is also provided for converting a container for wipes, typically the well-known sterile wipes, to an educational training device. These containers have a top, a bottom, an interior formed by walls, a container opening at the top of the container and an interior plate having an opening therein that is removably engaged with the walls.

The kit, comprises:
a compressible polymeric foam structure having a bottom surface, an upper surface and sidewalls; wherein the compressible polymeric foam structure is sized to fit below the interior plate of the container and have the bottom surface in contact with the bottom of the container; and

a plurality of reusable sheets that are not pre-moistened or wet having on at least one surface of each sheet an educational graphic.

The sheets are sized to be arranged in the container between the interior plate and the upper surface of the compressible polymeric foam structure so as to be capable of being dispensed one at a time from the opening in the interior plate.

The compressible polymeric foam structure is positioned between the interior plate and the bottom of the container maintains a continuous upward force for maintaining the sheets in constant contact with the interior plate as each of the reusable sheets are removed from the container to thereby provide access to the sheets through the opening in the interior plate.

Preferably, the compressible polymeric foam structure and the plurality of reusable sheets are contained in a package, e.g., a point-of-sale package.

### BRIEF DESCRIPTION OF THE DRAWINGS

Further aspects, features and advantages of the present invention will become even more apparent with reference to the following detailed description and the accompanying drawings.

FIG. 1 is a perspective view of one embodiment of the educational device of this invention with the container top closed.

FIG. 2 is a perspective view of the educational device shown in FIG. 1 with the container top opened to expose the top sheet therein with a portion of the educational graphic on the sheet being exposed.

FIG. 3 is top view of the educational device shown in FIG. 1 with the container top closed showing the top sheet therein in phantom.

FIG. 4 is top view of the educational device shown in FIG. 1 with the container top opened showing the top sheet therein.

FIG. 5 is a cross-sectional view taken along line 5-5 of FIG. 3 wherein the container top is closed.

FIG. 6 is a cross-sectional view taken along line 5-5 of FIG. 3 wherein the container top is opened and a sheet is being removed.

FIG. 7 is a cross-sectional view taken along line 7-7 of FIG. 5.

FIGS. 8 through 13 are embodiments of the reusable sheets having on each a different educational graphic on a surface thereof.

FIG. 14 is a perspective view of a second embodiment of the educational device of this invention with the container top closed.

FIG. 15 is a perspective view of the educational device shown in FIG. 14 with the container top opened to expose the top sheet therein with a portion of the educational graphic on the sheet being exposed.

FIG. 16 is top view of the educational device shown in FIG. 14 with the container top closed showing the top sheet therein in phantom.

FIG. 17 is top view of the educational device shown in FIG. 14 with the container top opened showing the top sheet therein.

FIG. 18 is a cross-sectional view taken along line 18-18 of FIG. 16 wherein the container top is closed.

FIG. 19 is a cross-sectional view taken along line 18-18 of FIG. 16 wherein the container top is opened and a sheet is being removed.

FIG. 20 is a cross-sectional view taken along line 20-20 of FIG. 18.

FIG. 21 is a schematic of a kit of this invention for converting the known tissue wipe holders to an educational device.

FIGS. 22-27 depict several embodiments of the educational training device 320, 420, 520, 620 of this invention utilizing different commercial containers. Each of these containers has a different configuration of opening. The elements in each of these drawings are similar to the previous Figures.

The drawings are not presented to scale but are only used to illustrate the principles of the invention. In the drawings, like reference numbers indicate like elements.

### DETAILED DESCRIPTION OF THE INVENTION

### First Embodiment of Invention

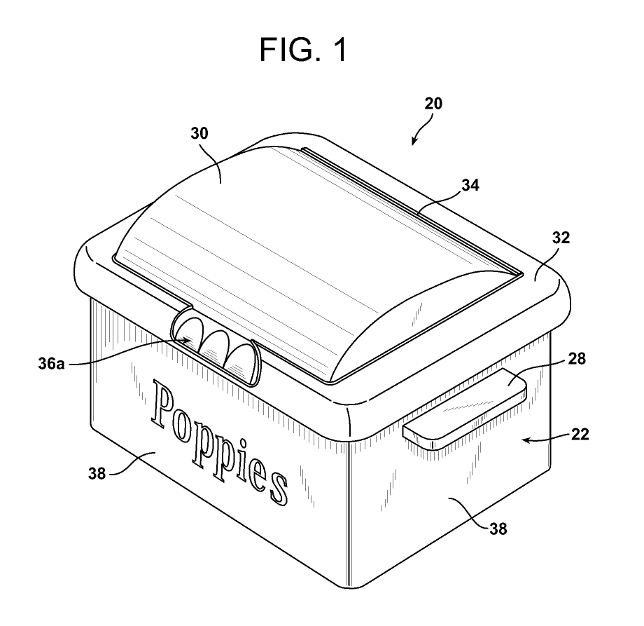

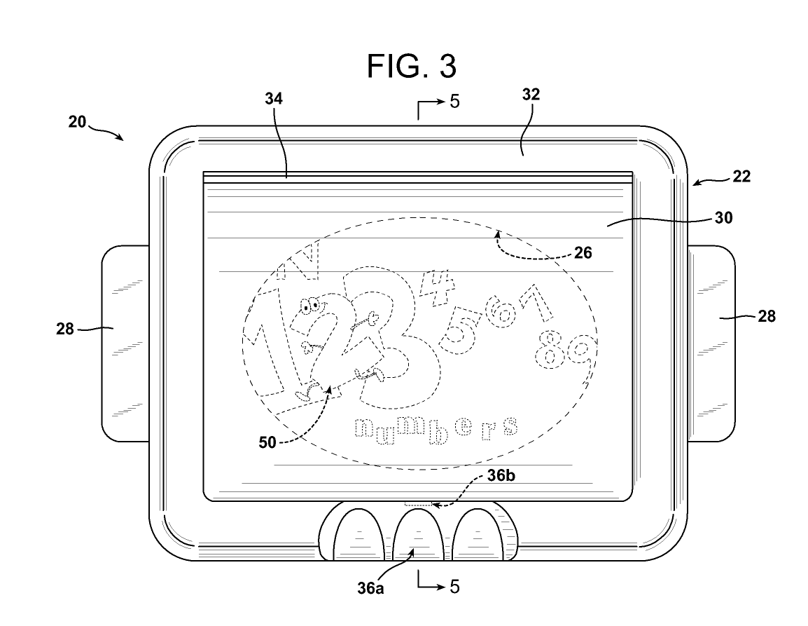

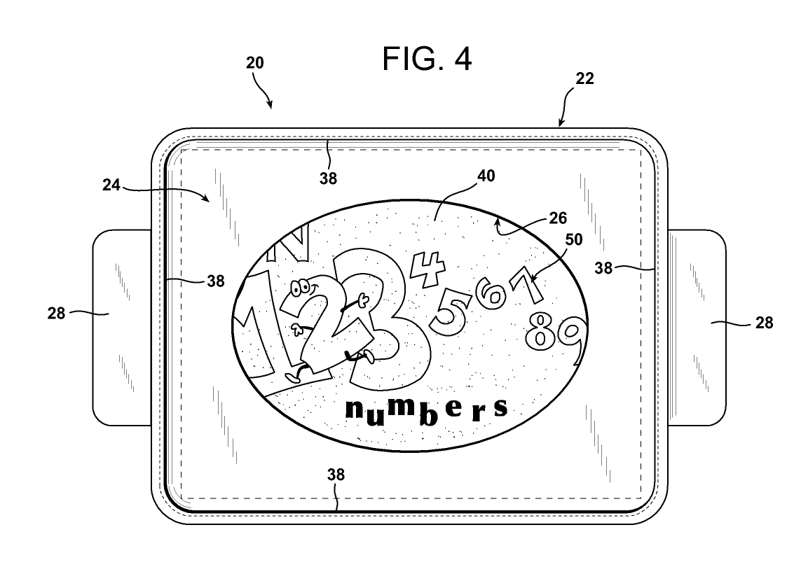

Referring to FIGS. 1-7, the educational training device of this invention, generally 20, comprises a freestanding dispenser container 22 having an interior 24 and an opening 26 to the interior 24. The container 22 is about 8½ inches wide by 5½ inches deep and 3 inches high. However, it is to be understood that the size is not critical. The size of the storage portion in the container 22 will depend upon many factors, such as but not limited to, the size of the reusable sheets 40, the number of sheets 40 in the container 22, ease of use by a child, etc. This storage portion may be accessed in any suitable fashion through an opening 26 of a size appropriate for the size of the sheets 40.

Referring to FIGS. 1, 3 and 4, the container 22 includes a projecting handle 28 on opposite sides of the container 22. The handles 28 are designed to permit them to be easily grasped by the user, typically a child.

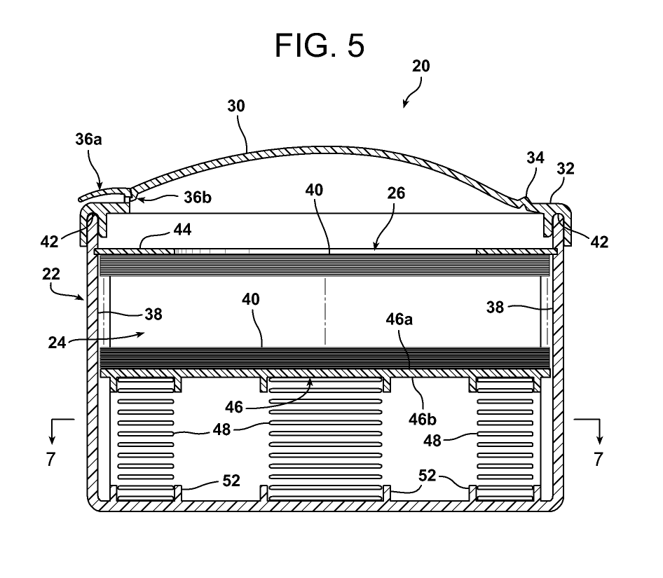

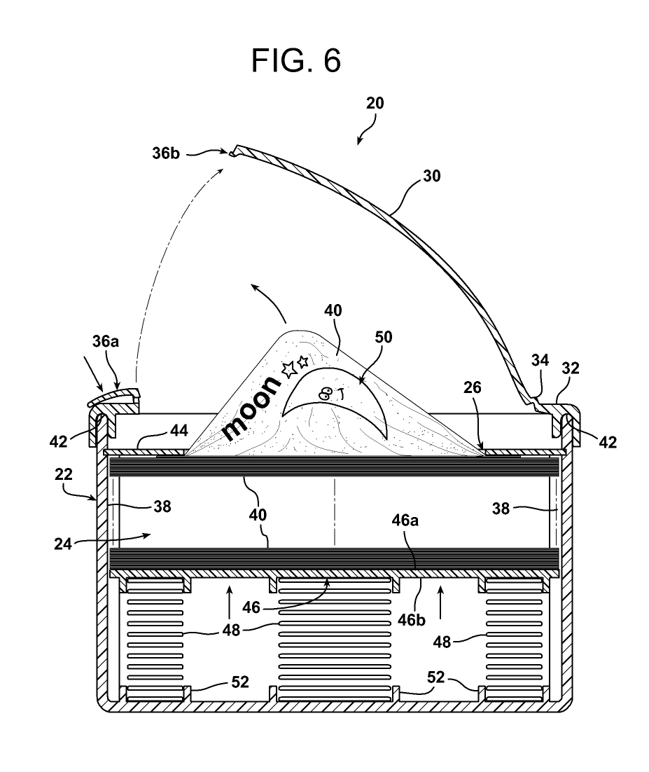

The container 22 is further provided with a lid 30 that is hingedly connected to the top 32 of the container 22 by a hinge means 34 joining the lid 30 and top 32 (see FIGS. 5 and 6). Any type hinge means 34 is contemplated that will permit the lid 30 to freely pivot open, preferably automatically by a spring action produced by the hinge means 34. The hinge means 34 depicted in the drawings is one formed by a flex line in the lid 30.

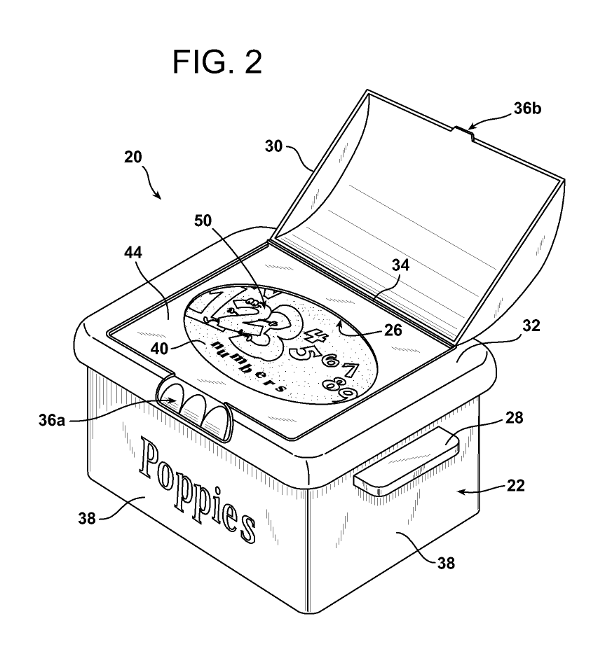

Referring to FIGS. 1-3, 5 & 6, the container 22 is further provided with a latch means 36a and 36b mounted to the top 32 of the container 22 opposite the hinge means 34. When the latch 36a is pressed downward, (see FIGS. 2 & 6) the latch 36b is released and the lid 30 automatically springs open, pivoting about hinge 34. The latch 36a should be of a size and shape to permit easy opening by a child. In a preferred embodiment the latch 36a measures about three inches wide by 2 inches deep and is centered near the edge of the top 32 of container 22. However, it should be understood that any size and type hinge means 34 may be used to maintain the lid 30 closed when desired and permit the release of the lid 30 when desired.

Referring, for example to FIGS. 2 & 4, when the lid 30 is opened it reveals an opening 26 that reveals the reusable sheets 40 enclosed therein. The reusable sheets 40 can be removed through the opening 40. The opening 40 in the embodiment depicted is about 4½ inches by 2½ inches and oval in shape. The sheets 40 are arranged in the container (see FIGS. 5 & 6) so as to be capable of being dispensed one at a time from the opening 26 by a person grasping and removing each sheet 40 sequentially from the container through the opening 26.

As indicated clearly in FIGS. 5 & 6, the lid 30 is removably mounted to the side walls 38 of the container 22. In the embodiment depicted the lid 30 has a channel 42 around the periphery thereof which removably, matingly engages the top of the side walls 38 of the container 22. The container 22 further includes interior plate 44 that slidably engages with the interior walls 38. The interior plate 44 functions to control the sequential removal of the sheets 40 from the container 22. In the embodiment depicted, the interior plate 44 has an oval opening 26 therein to permit the sheets 40 to pass therethrough. However, it is understood that the opening 26 can be any configuration that permits the sheets 40 to easily pass through when pulled from the container.

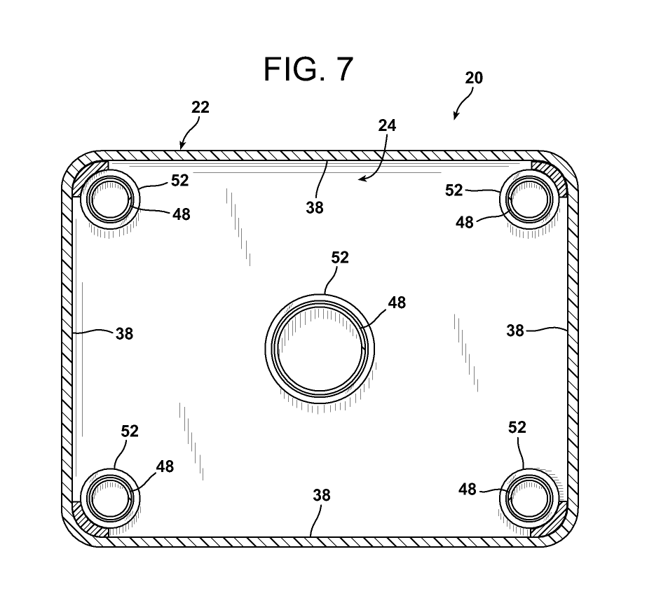

Referring to FIGS. 5, 6 & 7, the container 22 further includes, below interior plate 44, spring plate 46 that slidably engages with the interior walls 38 and the bottom of which 46b rests upon springs 48 that are contained, therein. In the embodiment depicted in FIGS. 5, 6 & 7, there are springs 48 that maintain a force (direction of arrows in FIG. 6) on the bottom (46b) of spring plate 46 so that the sheets 40 are maintained in contact with interior plate 44 so that they may be easily and sequentially removed as shown in FIG. 6. In the preferred embodiment depicted (see FIG. 7), the container 22 has five springs 48 held in place between the bottom 46b of the spring plate 46 and mating cylinder 52 on the interior bottom of the container, which provides stability to the springs 48. It should be realized that the specific configuration of springs 48 and spring plate 46 is not critical.

In order to replenish the container 22 with sheets 40, by for example, an adult, the top 32 is removed from the sidewalls 38 of the container 22 and then the interior plate 44 is removed from the container 22. The sheets 40 are then placed on top 46a of the spring plate 46; the interior plate 44 is then placed on top of the sheets 40 and pressed downward against springs 48. The top 32 is then mounted on the sidewalls 38 of the container 22, maintaining the sheets 40 in the container 22 with the spring plate 46 forcing the sheets 40 against the bottom of interior plate 44 to thereby provide easy access of the sheets through the opening 26 by the user. For example, when the child pulls one of the sheets 40 from the container 22, the springs 48 and interior plate 44 provide the appropriate tension to allow one sheet 40 to be removed, while retaining the remaining sheets 40 within the container 22 for the child to repeat the action of retrieval and play.

Optionally, the exterior sidewalls 38 of the container 22 may have graphics thereon, preferably similar to the educational graphics 50 used on the reusable sheets 40, and/or an appropriate brand and/or trademark.

The container 22 and graphics thereon may be made of many different type materials, most preferably materials that are child safe. Examples of materials that can be used for the container of this invention are, rigid or semi rigid plastics, recycled plastics, paper, metal, or a combination thereof. Most preferably, the container and associated elements are formed from a moldable plastic material. It may also be desirable for the container 22 to be formed from a transparent material so that a user can visually inspect the interior of the container and for educational purposes demonstrating the function of the sheet dispenser.

The embodiment shown in FIGS. 1-7 is an exemplary container 22 that has a rectangular shape and is suitable for dispensing rectangular sheets 40. It should be noted that the container and sheets of the present invention may have any other shape. Suitable shapes include, but are not limited to, rectangular, square, circular, oblong, rhombus, trapezoidal, barbell, diamond, or any other shape.

The container 22 may also include hooks, suction cups or the like, which enable the container to be retained on, for example, the side of a crib or flat surface. Preferably, however the container is a freestanding container that can be manipulated and used by the child.

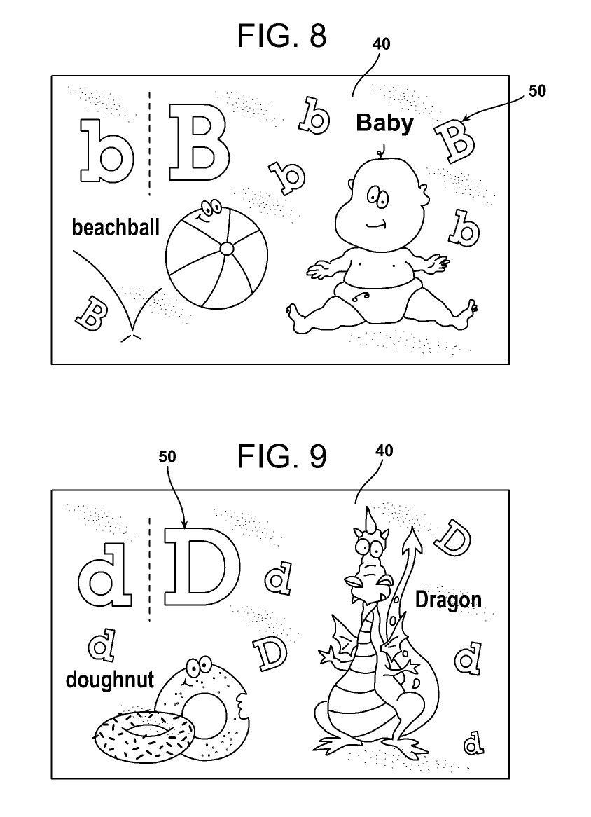

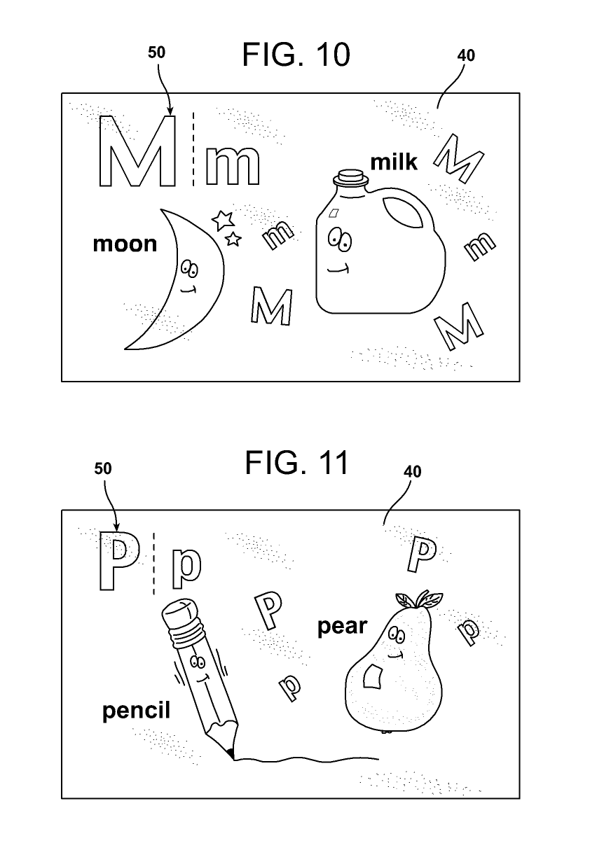

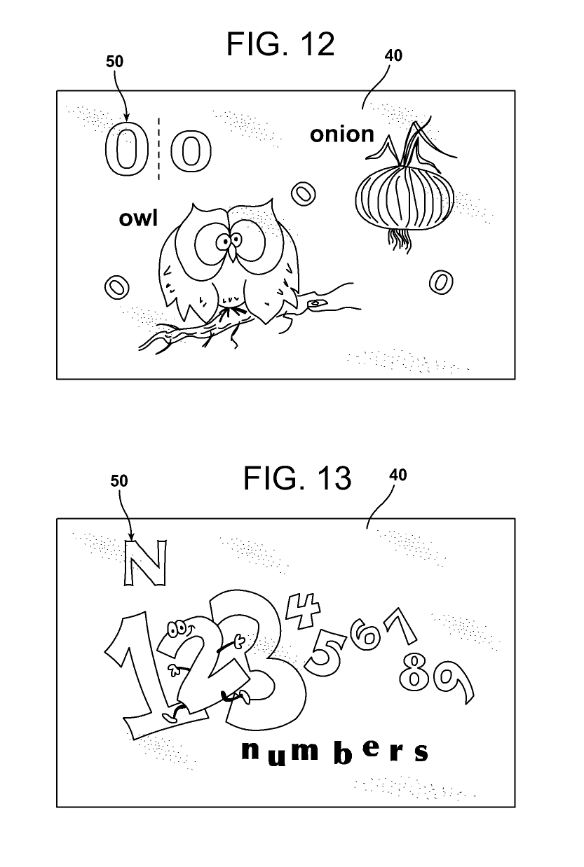

Referring to FIGS. 2-4, 6, and particularly FIGS. 8-13, the educational training device 20 of this invention includes a plurality of reusable sheets 40 each sheet having on at least one surface of thereof an educational graphic 50. The sheets 40 are arranged in the container 22 so as to be capable of being dispensed one at a time from the opening 26 by a person grasping and removing each sheet sequentially from the container through the opening (see FIG. 6).

### Second Embodiment of Invention

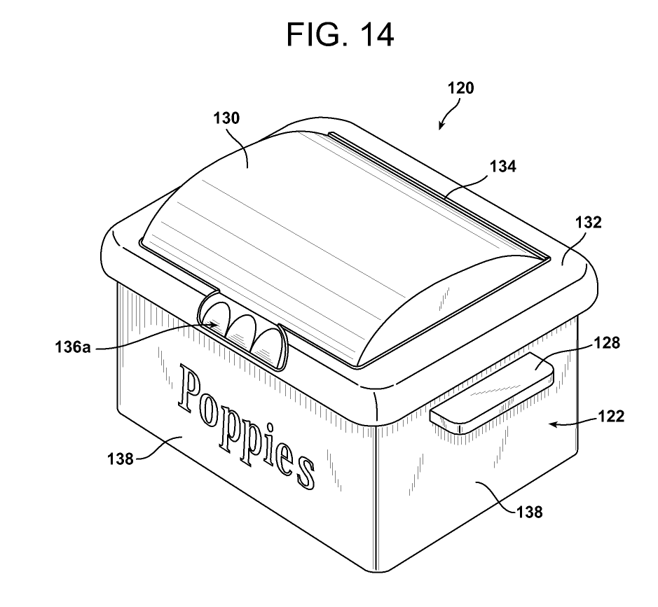

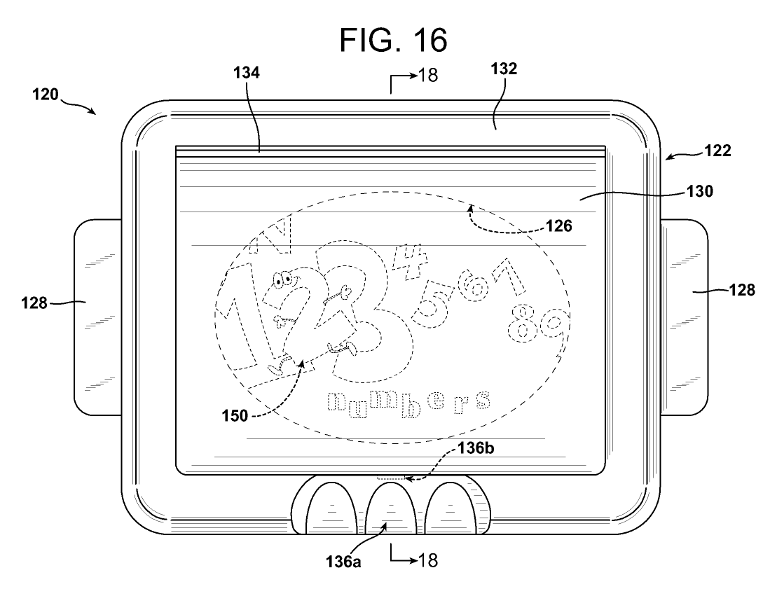

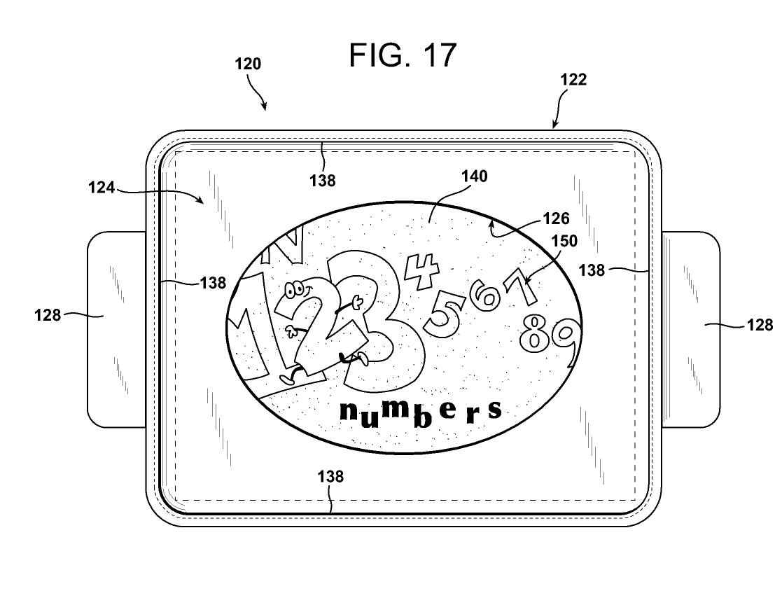

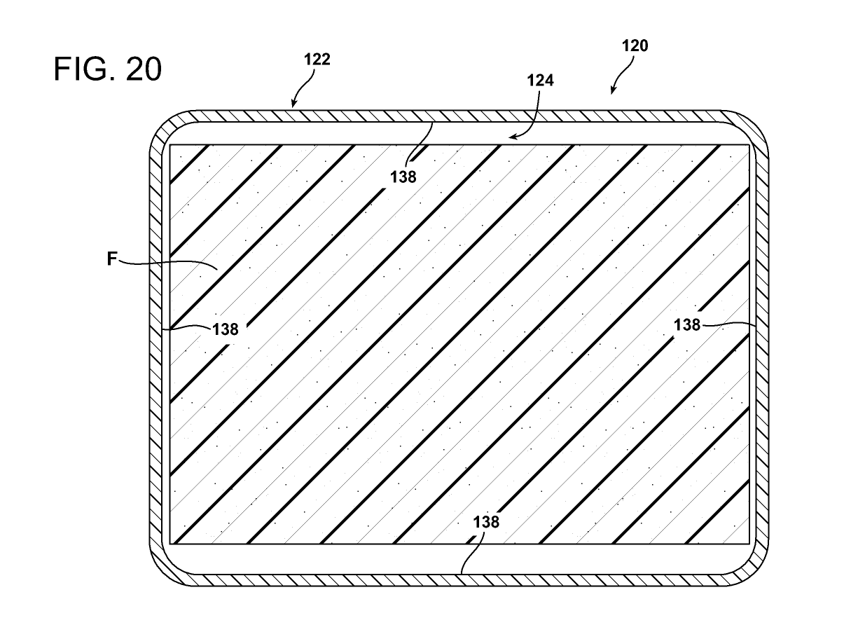

Referring to FIGS. 14-20, the second embodiment of the educational training, device of this invention, generally 120, comprises a freestanding dispenser container 122 having an interior 124 and an opening 126 to the interior 124. In this embodiment the container 120 is preferably a commercially available container used for baby wipes, e.g., Pampers® baby fresh®, Huggies®, America's Choice®, and Parent's Choice® brand baby wipes. The container 122 is usually about 4½ inches high, by 4½ inches deep and 7¾ inches wide. However, it should be understood that the size of the container is not critical and manufacturers use various size containers. The size of the storage portion in the container 122 will depend upon many factors, such as, but not limited to, the size of the reusable sheets 140, the number of sheets 140 in the container 122, ease of use by a child, etc. This storage portion may be accessed in any suitable fashion through an opening 126 of a size appropriate for the size of the sheets 140. The commercially available containers have various type openings and tops.

The kit of this invention is suitable for transforming the commercially available containers 120, e.g. Pampers® baby fresh®, Huggies®, America's Choice®, and Parent's Choice® brand baby wipes, into the educational training device of this invention.

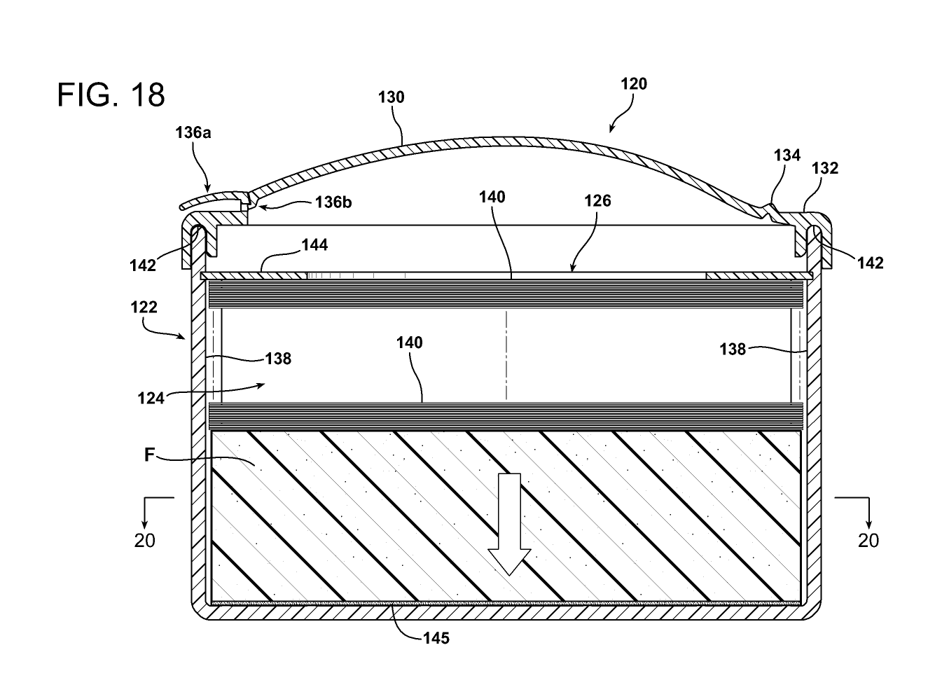

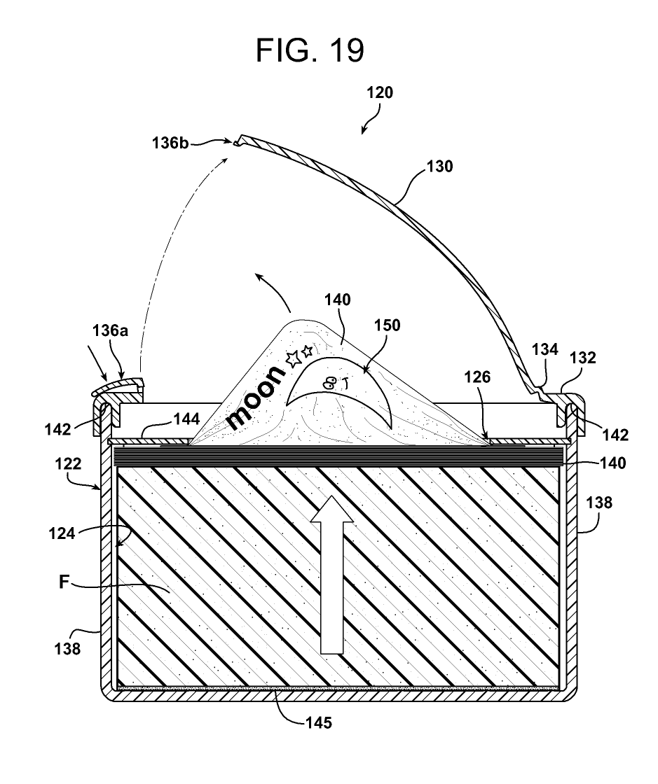

The commercially available container 122 is provided with a lid 130 that is usually, but not necessarily, hingedly connected to the top 132 of the container 122 by a hinge means 134 joining the lid 130 and top 132 (see FIGS. 18 and 19). Any type hinge means 134 is contemplated that will permit the lid 130 to freely pivot open, preferably automatically by a spring action produced by the hinge means 134. The hinge means 134 depicted in the drawings is one formed by a flex line in the lid 130.

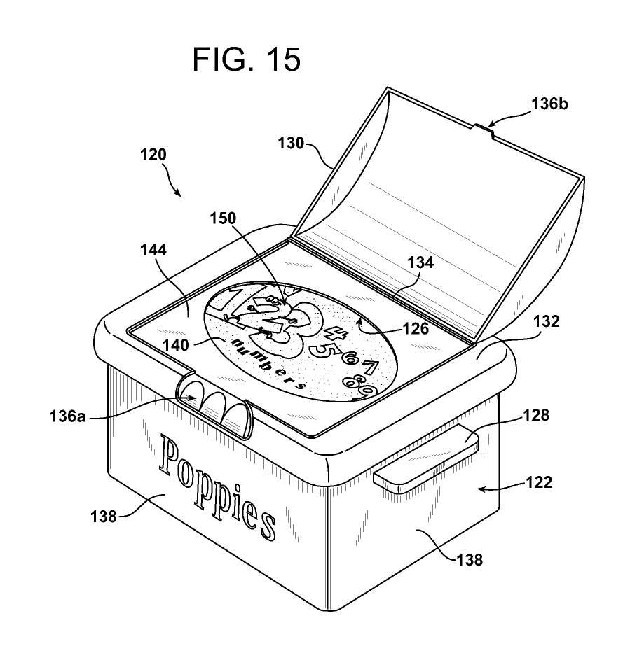

Referring to FIGS. 14-16, 18 & 19, the commercially available container 122 is usually provided with a latch means 136a and 136b mounted to the top 132 of the container 122 opposite the hinge means 134. When the latch 136a is pressed downward (see FIGS. 15 & 19) the latch 136b is released and the lid 130 automatically springs open, pivoting about hinge 134.

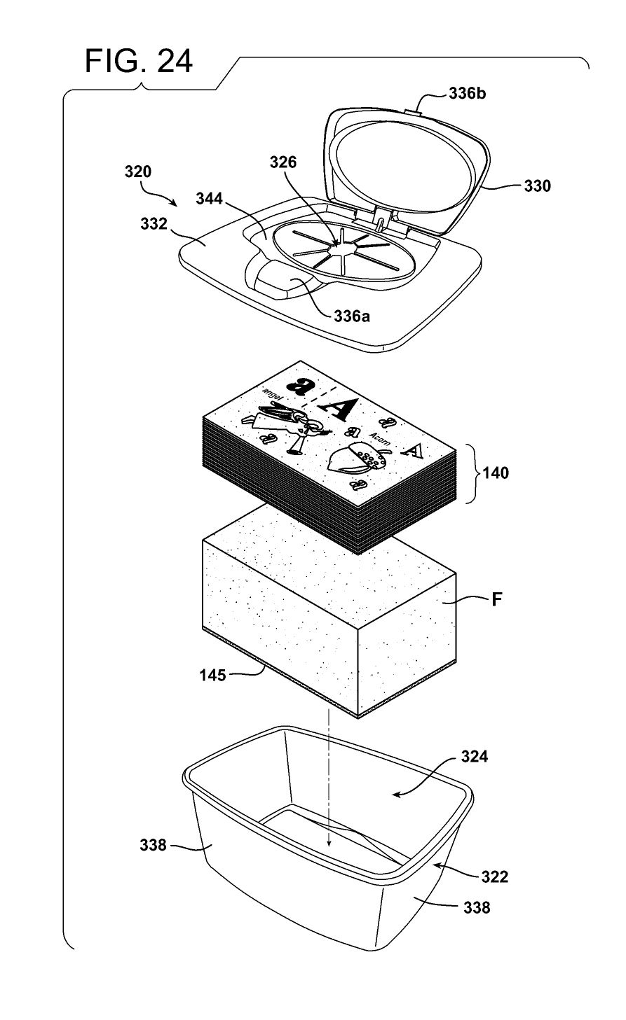

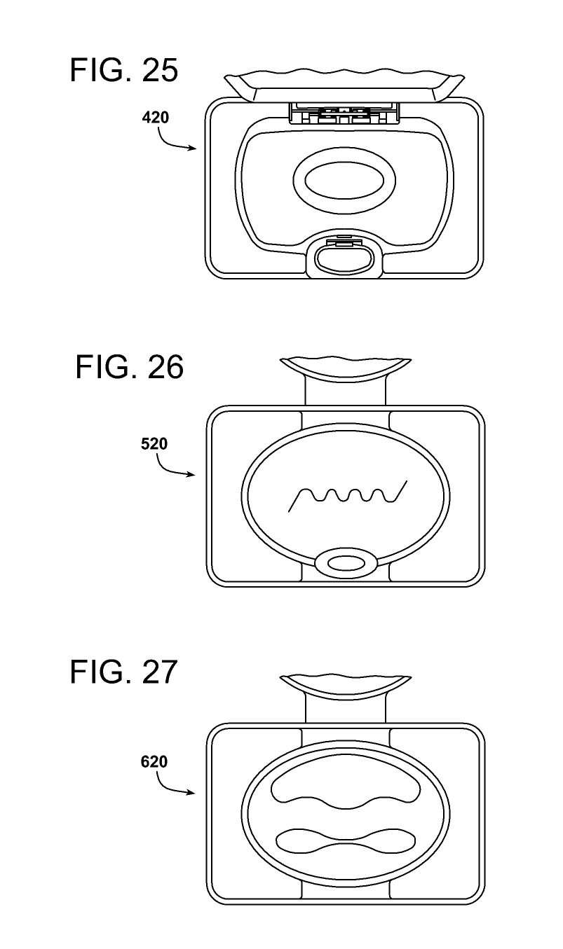

Referring, for example to FIGS. 15 & 17, when the lid 130 is opened it reveals an opening 126 that reveals the reusable sheets 140 enclosed therein. The reusable sheets 140 can be removed through the opening 126. The opening 126 in the embodiments depicted may be any configuration that permits the sheets 140 to be removed, e.g., oval, jagged. Each manufacturer generally has a uniquely configured opening. Reference is made to FIGS. 24-27, which depict various type openings for different brands of containers that are converted to the educational training device 320, 420, 520 and 620 of this invention. The sheets 140 are arranged in the container (see FIGS. 18 & 19) so as to be capable of being dispensed one at a time from the opening 126 by a person gasping and removing each sheet 140 sequentially from the container through the opening 126. The sheets 140 may be interleaved with each other, stacked or even put in randomly and crumpled as a child might do. The interplay between the sheets 140 makes any configuration of sheets suitable.

As indicated clearly in FIGS. 18 & 19, the lid 130 is removably mounted to the sidewalls 138 of the container 122. In the embodiment depicted the lid 130 has a channel 142 around the periphery thereof which removably, matingly engages the top of the side walls 138 of the container 122. The container 122 further includes interior plate 144 included in the lid 130. The interior plate 144 functions to control the sequential removal of the sheets 140 from the container 122.

Referring to FIGS. 18, 19 & 20, the container 122 further includes, below interior plate 144, a compressible polymeric foam structure F having a bottom surface in contact with the bottom of the container 122, an upper surface of the foam F is below the interior plate 144 and the sidewalls of the foam F are in close proximity or even in contact with, but not secured to, the side walls 138 of the container 122. The compressible polymeric foam structure F is an essential element of the kit of this invention.

The compressible polymeric foam structure F used in this invention is made from foams that are well known and widely available, and by processes that are well known. Any number of processes can make the foam, typically by mixing a solid, and a gas phase together to form the foam. The foam has a polymer matrix with either air bubbles or air tunnels incorporated in it, and can be either closed-cell or open-cell structures. Closed-cell foams are generally more rigid, while open-cell foams are usually flexible. In all such foams the cell or pore structure is not a specific uniform unit, there is instead a wide range of different sized cells and pores and a certain amount that are closed-cell and open-cell although one will be the dominating structure. The mechanical response of the foam is also dictated by the structure. In an open-cell structure, the gas phase is not held together and the foam can compress much more. The foam will reform by sucking up air again, but will not be able to mimic its original shape exactly and the strength and energy absorption of the system will be weaker.

The cells in the foam deform to absorb the energy impact and then reform when the load is removed. The polymer foam has to be able to resist multiple loadings, and resist change to the structure so the loading can be repeated many times. The foam must be suitable for use by children, non-toxic and preferably washable. However, it is to be understood that the foam structure F may be replaced when dirty or worn by another foam structure F.

Referring to FIG. 19, preferably, although not necessarily, there is an adhesive layer 145 mounted to the bottom surface of the compressible polymeric foam structure F to enable the bottom surface of compressible polymeric foam structure F to be adhesively mounted to the bottom of the container 122. Preferably, the foam structure F is adhesively and removably mounted to the bottom of container 122 for easy replacement of the structure F.

The compressible polymeric foam structure F is positioned between the interior plate 144 and the bottom of the container 122 and maintains a continuous upward force for maintaining the sheets 140 in constant contact with the interior plate 144 as each of the reusable sheets 144 are removed from the container to thereby provide access to the sheets through the opening 126 in the interior plate 144.

In order to replenish the container 122 with sheets 40, by for example by an adult or even the child, the top 132 is removed from the sidewalls 138 of the container 122 and then the interior plate 144 is removed. The sheets 140 are then placed on top of the compressible polymeric foam structure F, the top 132 and interior plate 144 are then mounted on the sidewalls 138 of the container 122, maintaining the sheets 140 in the container 122 with the compressible polymeric foam structure F forcing the sheets 140 against the bottom of interior plate 144 to thereby provide easy access of the sheets through the opening 126 by the user.

For example, when the child pulls one of the sheets 140 from the container 122 the compressible polymeric foam structure F and interior plate 144 provide the appropriate tension to allow one sheet 140 to be removed, while retaining the remaining sheets 140 within the container 122 for the child to repeat the action of retrieval and play.

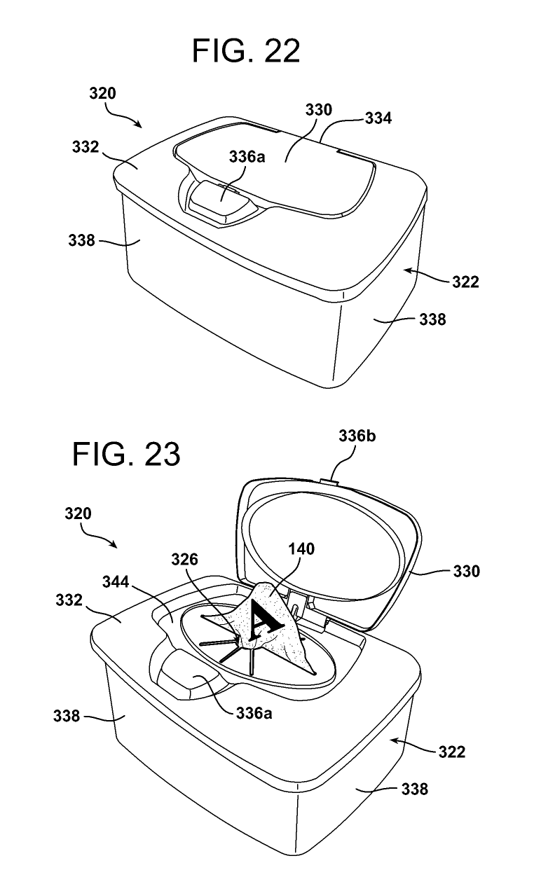

FIGS. 22-27 depict several embodiments of the educational training device 320, 420, 520, 620 of this invention utilizing different commercial containers. Each of these containers has a different configuration of opening. The elements in each of these drawings are similar to the previous Figures. In particular, the elements in FIGS. 22-24 are:
140 educational sheets
320 educational training device
322 container
324 interior
326 opening
330 lid
332 top
334 hinge
336a latch
336b latch
338 sidewalls
344 interior plate
F Foam

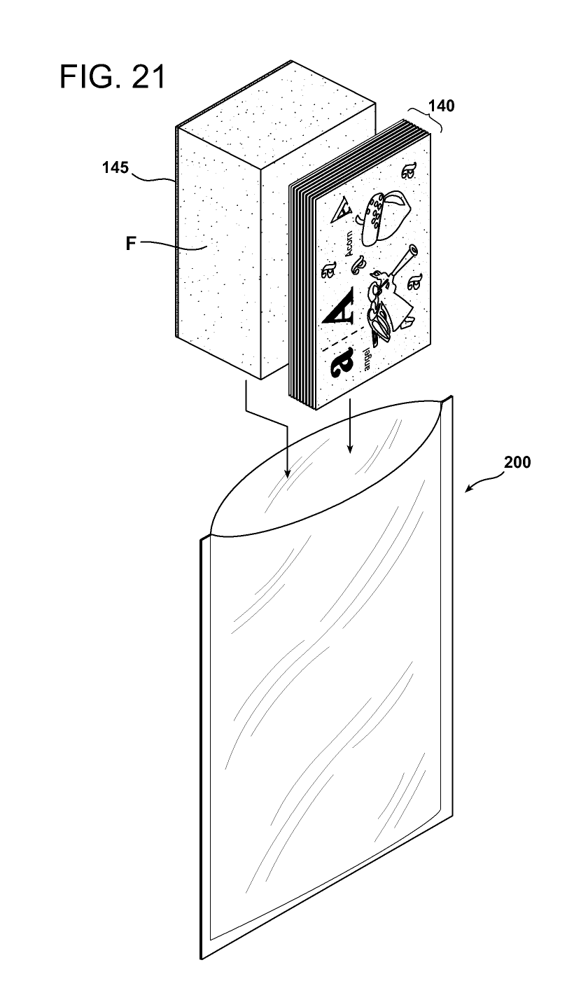

Referring to FIG. 21, a kit 200 is provided for converting the commercially available containers used for wipes into the educational training device of this invention, i.e., 120, 320, 420, 520, 620.

The kit includes a compressible polymeric foam structure F. The compressible polymeric foam structure F is sized to fit below the interior plate of the container and have the bottom surface in contact with the bottom of the container, the container being the commercially available containers after the wipes are removed.

The kit further includes a plurality of reusable sheets 140 that are not pre-moistened or wet. The sheets have on at least one surface of each sheet an educational graphic. The sheets are sized to be arranged in the container between the interior plate and the upper surface of the compressible polymeric foam structure F so as to be capable of being dispensed one at a time from the opening in the interior plate by a person grasping and removing each sheet sequentially through the container opening.

The kit 200 may include one or several foam structures F and one or several sets of reusable sheets, e.g., a set of sheets teaching numbers, a set of sheets teaching letter, or a set of sheets teaching words.

Preferably, the kit further includes an adhesive layer mounted to the bottom surface of the compressible polymeric foam structure F to enable the bottom surface of compressible polymeric foam structure F to be adhesively mounted to the bottom of the container. Optionally, and preferably the adhesive layer mounted to the bottom surface of the compressible polymeric, foam structure F enables the bottom of the foam to be adhesively and removably mounted to the bottom of the container. This can be done with a double sided adhesive tape or sheet. The compressible polymeric foam structure F and the plurality of reusable sheets 140 may be contained in a package, which may be a Zip-Locked® brand bag or sealed. They may also be sold separately. Printing, coloring and branding may be on the package. Optionally it could be a point of sale package.

The term “reusable” is used herein to describe sheets that are intended to be laundered or otherwise restored or reused after a single or multiple uses. It is highly preferred that the sheets 40 be capable of being washed numerous times because they will get dirty when used by children and it will be useful to keep them for many uses so that the child can learn through the repetition produced by such multiple uses.

The sheets 40 within the container 22 are releasably layered to form a stack, i.e., layered and stacked but not attached to each other. Optionally, it has been found that randomly passing the crumpled sheets into the container is just as effective as stacking them neatly and has the advantage of being easier for children. Exemplary of individual sheets suitable for use are shown in FIGS. 8-13. Preferably, the sheets are about 8 inches by about 5 inches, although, as indicated different sizes and shapes are contemplated and may be used.

The sheets 40 must be reusable and capable of maintaining thereon an educational graphic throughout such use. The sheets 40 therefore can be made of any flexible material that fulfills such requirement. Most preferably such sheets are child safe. However, if used for educational purposes for adults, such functionality is not a necessary requirement.

The sheets used in this invention are not pre-moistened or wet and are not treated with any chemical that can transfer to the hand or body when used. The sheets are designed to be reusable and to be washed numerous times for reuse. The material of which the sheets are made from should be strong enough to resist tearing during normal use, and preferably provide certain softness to a child's skin. Additionally, the material should be washable and capable of retaining its form after numerous washes.

The sheets 40 used in this invention can be either woven or nonwoven. The use of the term “woven” as used herein refers to paper, tissue paper, and products which are woven, knitted, tufted, or stitch-bonded. The use of the term “nonwoven” as used herein refers to a sheet, web, or batt of directionally or randomly oriented fibers, bonded by friction, and/or cohesion and/or adhesion, excluding. The nonwoven sheet can be a mixture of natural fibers and synthetic fibers or may wholly comprise natural fibers or synthetic fibers. Additionally, each nonwoven sheet member may be made of material which is the same or different from that of the other nonwoven sheet member. Suitable natural fibers include but are not limited to cellulosic fibers, such as wood pulp fibers, cotton, and rayon. Suitable synthetic fibers include fibers commonly used in textiles, including but not limited to polyester and polypropylene fibers polyethylene, polyether, polyethylene terephthalate (PET), and combinations thereof. Suitable nonwovens with good softness include, but are not limited to, nonwoven materials comprising, polypropylene, polyethylene, cellulose, rayon, polyether, PET, bicomponent polymers, and combinations thereof. It is also within the scope of the present invention that the sheets may comprise laminates of two or more substrates or webs. Additionally, the sheets may be flat or textured. The surface of the sheets may optionally contain raised and/or lowered portions. These can be in the form of logos, indicia, trademarks, geometric patterns and/or educational graphics. The graphics may be randomly arranged on the surface of the sheets or be in a repetitive pattern of some form. They may be on one or both of the sides or surfaces of the sheet. The sheets may be biodegradable so that when disposed of they do not contaminate the environment.

Each reusable sheet 40 will have thereon an educational graphic 50 that can educate a person, preferably a child, through repetition and sequential viewing. It should also be understood that this invention, although the preferred embodiment is for children, can also be used to amuse and educate adults. The educational graphics 50 used on the sheets 40 can include an assortment of pictures, names, numbers, shapes, and colors. Such graphics 50 are used to provide tactile stimulation, visual stimulation, to promote small and gross motor skills, to promote independent play and to provide a variety of learning experiences, language development, and letter recognition.

The educational graphics can be formed or applied directly or indirectly to a surface of a sheet. The graphics may be printed, sprayed, or otherwise applied directly onto a surface of the reusable sheet 40.

As used herein, the term “graphic” means any design, shape, pattern, or the like that is or becomes visible on the sheet, and specifically includes text messages, that include one or more alphanumeric symbol, pictorial images that consist of one or more pictures, and combination thereof.

As used herein, the term “children's educational graphic” means any graphic which appeals to a child such that the child will want to possess and/or interact with the reusable sheet on which such graphic is disposed and will provide some form of education. The education provided may be on any suitable subject matter, such as but not limited to, providing advice to the child on any of a range of diverse subjects such as numbers, letters, words, shapes and the like, child appropriate facts and factoids, and combinations thereof; sports and games; jokes, rhymes, limericks humorous stories and the like; social and religious issues, such as but not limited to, sharing and caring, bullying, civics, and the like; safety, such as but not limited to, stranger danger, road safety, hygiene, (i.e., hand washing, bottom wiping and the like); and combinations thereof.

Without wishing to be limited to the specific embodiments listed, suitable examples of children, educational graphics may include:

Alphabet:

apple, ant; ball, baby; car, cup; duck, dog; egg, eyeglasses; flower, frog; goose, grass; hat, house; ice cream, igloo; juice box, jet; keys, kite; ladybug, lamb; moon, milk; necklace, numbers; octopus, owl; pail, pacifier; queen, quilt; rainbow, rattle; sun, shovel; train, teddy; unicorn, umbrella; violin, violet; whale, whistle; xylophone, x-ray; yo-yo, yarn; zoo, zipper.

Colors:

Yellow, Red, Orange, Blue, Green, Purple, White, Black, Pink.

Household Pets:

cat, dog, bird, fish, turtle, hamster, guinea pig, hermit crab, lizard, rabbit.

Zoo Animals:

lion, tiger, giraffe, elephant, monkey, hippopotamus, zebra, gorilla, alligator, snake.

Farm Animals:

horse, cow, pig, sheep, goat, duck, chicken, rooster, cat with kittens, dog with puppies.

Shapes:

circle, oval, square, rectangle, triangle, diamond, star, pentagon, hexagon, octagon.

Numbers:

one, two, three, four, five, six, seven, eight, nine, ten.

Musical Instruments:

drums, moroccos, flute, piano, violin, trumpet, rhythm sticks, guitar, tambourine, saxophone.

Articles of Clothes:

shirt, socks, shoes, pants, skirt. dress. jacket. hat, mittens, boots.

Sports Balls:

baseball, football, soccer ball, basketball, tennis ball, golf ball, volleyball, playground ball, ping-pong ball, beach ball.

Vegetables:

carrots, broccoli, corn, string beans, peas, potato, yams, peppers, spinach, lettuce.

Parts of the Body:

head, arm, leg, abdomen, hands, feet, eyes, nose, mouth, ear.

Kitchen Items:

dish, cup, glass, knife, fork, spoon, pot, table, chairs, highchair.

Seasonal Items Winter and Spring:

snowflake, snowman, icicle, snow clothes (hat, scarf, mittens, snow boots, ice-skates; flowers, trees with green leaves, watering can, garden, bunny with babies in a burrow.

Seasonal Items Summer and Fall:

sunshine, swimming pool, beach with sand, pail and shovel, ice pops; pile of leaves, trees with colored leaves, pumpkins, Indian corn, haystack.

Outdoor Play Items:

sandbox, swings, tricycle, ride on toy car, wagon, bicycle, slide.

Seasonal Holidays:

New Years, Kwanza, Valentines, St. Patrick's, Easter, Fourth of July, Halloween, Thanksgiving, Christmas, Hanukkah.

The children educational graphic may vary depending upon the age and/or developmental stage of the child. Typically, this would mean when a graphic is intended for a younger child, i.e., 3 or 4 years old, or an infant, i.e., 6-18 months, the graphics will be simpler in nature and comprise bright colors, and typically be easily identifiable and relatable to by a child of that age. The selection of available colors as well as the possible complexity of the child graphics may be increased as the age of the intended child increases. Typically, the older the intended child the more colors, especially subtle colors shades etc., and complex images are available for use on the article.

The graphic may also vary depending upon the gender of the intended child; for example, the graphic may comprise colors and images which are appealing to girls, such as pinks and images of dolls, rabbits, doll houses and the like or the graphic may comprise colors and images which are appealing to boys, such as blues and rockets, construction machines, trains and the like. Alternatively, the graphic may comprise colors and images, which are gender neutral and are appealing equally to girls and boys such as purples and greens and cartoon characters, or the child graphic may comprise colors and images, which comprise parts, which are appealing to boys, parts that are appealing to girls, and is overall appealing to both boys and girls.

The graphic may be a sequential series of panels, wherein each of the panels contains, for example, a different cartoon, symbol, drawing, photograph and combinations thereof. Alternatively, each panel may contain one or more graphics.

The sheets 40, for example, may be placed in the container 22 in an interfolded, layered or stacked relationship and positioned to be dispensed from the container 22 through the opening 26. The sheets may be interfolded such that when the leading sheet is dispensed from the opening 26 a preceding sheet is partially withdrawn through the opening 26.

The invention has been described with reference to various specific and illustrative aspects of the present invention and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the appended claims.

What is claimed is:

1. An educational training device for a person, comprising:
a freestanding dispenser container having a top, a bottom, an interior formed by walls, and a container opening at the top of the container;
a plate removably engaged with the walls having an opening through the plate;
a compressible polymeric foam structure having a bottom surface in contact with the bottom of the container, an upper surface below the plate and sidewalls;
a plurality of reusable sheets that are not pre-moistened or wet_having on at least one surface of each sheet an educational graphic, the sheets being arranged in the container between the plate and the upper surface of the compressible polymeric foam structure so as to be capable of being dispensed one at a time from the opening in the plate by a person grasping and removing each sheet sequentially through the container opening; and
wherein the compressible polymeric foam structure positioned between the plate and the bottom of the container maintains a continuous upward force for maintaining the sheets in constant contact with the plate as each of the reusable sheets are removed from the container to thereby provide access to the sheets through the opening in the plate;
whereby a person can remove each reusable sheet from the container by pulling on the sheet through the opening in the plate, view the educational graphic on the sheet, and sequentially repeat the process until the container is empty of reusable sheets, the compressible polymeric foam structure maintaining the reusable sheets in constant contact with the plate, and then refill the container with the plurality of sheets that have been removed from the container by disengaging the plate from the walls and placing the sheets on top of the compressible polymeric foam structure, returning the plate to its original position engaged with the walls and repeating the process.

2. An educational training device for a person, comprising:
a free-standing dispenser container having a top, a bottom and an interior formed by walls, a container opening at the top of the container and a lid to close the container opening,
wherein the lid is hingedly connected to the top of the container by a hinge to permit the lid to freely pivot to an open and closed position, and a latch means mounted to the top of the container for selectively maintaining the lid closed or open for access to the interior of the container;
an interior plate below the lid and removably engaged with the walls having an opening through the interior plate;
a compressible polymeric foam structure having a bottom surface in contact with the bottom of the container, an upper surface below the interior plate and sidewalls;
a plurality of reusable sheets that are not pre-moistened or wet having on at least one surface of each sheet an educational graphic, the sheets being arranged in the container between the interior plate and the upper surface of the compressible polymeric foam structure so as to be capable of being dispensed one at a time from the opening in the interior plate by a person grasping and removing each sheet sequentially through the container opening; and
wherein the compressible polymeric foam structure positioned between the interior plate and the bottom of the container maintains a continuous upward force for maintaining the sheets in constant contact with the interior plate as each of the reusable sheets are removed from the container to thereby provide access to the sheets through the open lid and opening in the interior plate;
whereby when the lid is open a person can remove each reusable sheet from the container by pulling on the sheet through the opening in the interior plate and open container, view the educational graphic on the sheet, and sequentially repeat the process until the container is empty of reusable sheets, the compressible polymeric foam structure_continuously maintaining the reusable sheets in contact with the interior plate, and then refill the container with the plurality of sheets that have been removed from the container by disengaging the interior plate from the walls and placing the sheets on top of the compressible polymeric foam structure, returning the interior plate to its original position engaged with the walls and repeating the process.

3. The educational training device of claim 2, wherein the hinge is a flex line at a juncture between the lid and the top of the container that permits the lid to automatically spring open, pivoting about the hinge when the latch means releases the lid.

4. The educational training device of claim 1, wherein the plurality of sheets comprise unattached individual sheets that are interfolded.

5. The educational training device of claim 1, wherein the plurality of sheets are arranged randomly in the container between the plate and the upper surface of the compressible polymeric foam structure.

6. The educational training device of claim 1, wherein the educational graphic is a children's educational graphic.

7. The educational training device of claim 1, wherein the educational child graphic comprises a graphic selected from the group consisting of letters of the alphabet, colors, household pets, zoo animals, farm animals, shapes, numbers, musical instruments, articles of clothes, sports balls, vegetables, parts of the body, kitchen items, seasonal items, outdoor play items, and seasonal holidays.

8. The educational training device of claim 1, wherein the bottom surface of the compressible polymeric foam structure is adhesively mounted to the bottom of the container.

9. The educational training device of claim 1, wherein the bottom surface of the compressible polymeric foam structure is adhesively and removably mounted to the bottom of the container.

10. A kit for converting a container for wipes to an educational training device, the container having a top, a bottom, an interior formed by walls, a container opening at the top of the container and an interior plate removably engaged with the walls having an opening through the interior plate, the kit comprising:
a compressible polymeric foam structure having a bottom surface, an upper surface and sidewalls; wherein the compressible polymeric foam structure is sized to fit below the interior plate of the container and have the bottom surface in contact with the bottom of the container;
a plurality of reusable sheets that are not pre-moistened or wet having on at least one surface of each sheet an educational graphic,
wherein the sheets are sized to be arranged in the container between the interior plate and the upper surface of the compressible polymeric foam structure so as to be capable of being dispensed one at a time from the opening in the interior plate by a person grasping and removing each sheet sequentially through the container opening; and
wherein the compressible polymeric foam structure when positioned between the interior plate and the bottom of the container maintains a continuous upward force for maintaining the sheets in constant contact with the interior plate as each of the reusable sheets are removed from the container to thereby provide access to the sheets through the opening in the interior plate;
wherein a person can remove each reusable sheet from the container by pulling on the sheet through the opening in the interior plate, view the educational graphic on the sheet, and sequentially repeat the process until the container is empty of reusable sheets, the compressible polymeric foam structure maintaining the reusable sheets in constant contact with the interior plate, and then refill the container with the plurality of sheets that have been removed from the container by disengaging the interior plate from the walls and placing the sheets on top of the compressible polymeric foam structure, returning the interior plate to its original position engaged with the walls and repeating the process.

11. The kit of claim 10, further comprising an adhesive layer mounted to the bottom surface of the compressible polymeric foam structure to enable the bottom surface of compressible polymeric foam structure to be adhesively mounted to the bottom of the container.

12. The kit of claim 10, further comprising an adhesive layer mounted to the bottom surface of the compressible polymeric foam structure to enable the bottom surface of compressible polymeric foam structure to be adhesively and removably mounted to the bottom of the container.

13. The kit of claim 10, wherein the compressible polymeric foam structure and the plurality of reusable sheets are contained in a package.

14. The kit of claim 10, wherein the compressible polymeric foam structure and the plurality of reusable sheets are contained in a point of sale package.
